(19) United States
(12) Patent Application Publication
(10) Pub. No.: US 2025/0326434 A1
(43) Pub. Date: Oct. 23, 2025

(54) Method and Apparatus for Preventing Excessive Steering

(71) Applicants: Hyundai Motor Company, Seoul (KR); Kia Corporation, Seoul (KR)

(72) Inventor: Jong Hyup Lee, Seoul (JP)

(21) Appl. No.: 18/967,994

(22) Filed: Dec. 4, 2024

(30) Foreign Application Priority Data
Apr. 19, 2024 (KR) 10-2024-0052963

(51) Int. Cl. B62D 6/02

(52) U.S. Cl. CPC B62D 6/02

(57) ABSTRACT

A method and an apparatus prevents excessive steering. The method may allow for controlling a vehicle by obtaining a longitudinal acceleration of the vehicle, determining a limit lateral acceleration based on the longitudinal acceleration of the vehicle, determining a limit steering angle based on the limit lateral acceleration, determining whether a current steering angle exceeds the limit steering angle and suppressing excessive steering angle of the vehicle in response to a determination that the current steering angle exceeds the limit steering angle.

### CROSS-REFERENCE TO RELATED APPLICATION

This application claims priority to Patent Application No. 10-2024-0052963, filed on Apr. 19, 2024 in Korea, the entire contents of which are incorporated herein by reference.

### TECHNICAL FIELD

The present disclosure relates to a method and apparatus for preventing excessive driver steering input.

### BACKGROUND

The content described below simply provides background information related to this example and does not constitute prior art.

In dangerous situations where a collision with an obstacle is expected/may occur, a driver may over- or understeer. Excessive steering input from a panicked driver may result in a steering angle that exceeds stability margin of a vehicle. The stability margin of the vehicle is determined by a friction limit between tires and a road surface. For example, excessive steering at high speed may result in unstable behavior such as understeer or oversteer.

In general, as a power steering system may allow for reducing a steering force of a driver when steering a car. Examples of power steering systems may include a HPS (Hydraulic Power Steering) system or a MDPS (Motor Driven Power Steering) system. The HPS system is a system that assists a steering force of a driver using hydraulic pressure generated by a hydraulic pump. The MDPS system is a system that assists a steering force by using an output torque of an electric motor.

The MDPS system can control the output torque of the electric motor (e.g., steering motor) for steering assistance according to the driving conditions of the vehicle. As such, in the MDPS system, it is possible to provide improved steering performance and steering feel compared to the HPS system. Accordingly, the MDPS system, which can change and control the steering assistance force generated by motor output according to driving conditions, is widely applied to recently released vehicles.

A steering angle of a vehicle is generated by a steering torque of a driver and the motor torque generated from the MDPS system acting together. Using the MDPS system, the steering angle can be amplified and/or reduced. For example, a safety control algorithm can amplify the amount of steering when a steering angle of a driver is insufficient in a dangerous situation that requires steering avoidance.

Power steering systems aim at reducing resistance torque, accurately following an avoidance path, and ensuring straight-line stability when the driver steers, but do not prevent excessive steering of the vehicle. When the vehicle becomes unstable due to excessive steering of the driver, obstacle avoidance performance targeted by the autonomous safety function cannot be guaranteed. During emergency steering avoidance behavior, it is beneficial to suppress excessive steering of a driver input, for example, to the extent that the vehicle becomes unstable.

The matters described in this Background section are only for enhancement of understanding of the background of the disclosure, and should not be taken as acknowledgment that they correspond to prior art already known to those skilled in the art.

### SUMMARY

The following summary presents a simplified summary of certain features. The summary is not an extensive overview and is not intended to identify key or critical elements.

Systems, apparatuses, and methods are described an autonomous driving vehicle and control method thereof. A method performed by an apparatus of a vehicle may comprise detecting, via an acceleration sensor of the vehicle, a longitudinal acceleration of the vehicle; determining, by the apparatus and based on the detected longitudinal acceleration of the vehicle, a limit lateral acceleration; determining, by the apparatus and based on the limit lateral acceleration, a limit steering angle; detecting, via a steering angle sensor associated with a steering wheel of the vehicle, a current steering angle; and transmitting, based on the current steering angle exceeding the limit steering angle, a control signal, from the apparatus to a power steering system of the vehicle, to suppress an excessive steering angle of the vehicle.

One or more operations described herein may be performed by the apparatus of the vehicle, and one or more features described herein may be implemented in the apparatus of the vehicle.

The determining the limit steering angle may comprise determining a limit curvature. The determining the limit curvature may comprise determining, by the apparatus the limit curvature based on information of the limit lateral acceleration and a current vehicle speed. The determining the limit lateral acceleration may comprise determining, by the apparatus, the limit lateral acceleration based on, for each tire, at least one of: a normal force, a lateral force, or a longitudinal force.

The determining the limit lateral acceleration may comprise determining, by the apparatus, the limit lateral acceleration based on at least one of a mass of the vehicle, a moment of inertia of the vehicle, a wheelbase length of the vehicle, a center of gravity position of the vehicle, or a vehicle width.

The determining the limit lateral acceleration may comprise determining, by using a map, the limit lateral acceleration based on the longitudinal acceleration, wherein the map indicates coordinates determined by a plurality of longitudinal acceleration values and a plurality of limit lateral accelerations values, and wherein each of the plurality of longitudinal acceleration values corresponds to one of the plurality of longitudinal acceleration values. The determining the limit steering angle may comprise calculating, by the apparatus, the limit steering angle based on the longitudinal acceleration at which all tires are subjected to frictional force within a stable friction region.

The excessive steering angle may be suppressed by generating, by the power steering system, a reverse torque. The method may further comprise causing output, based on the current steering angle being predicted to exceed the limit steering angle, of a warning signal via an output device of the vehicle.

An apparatus for controlling a vehicle may comprise a communication interface; a memory storing one or more instructions; and one or more processors configured to execute the one or more instructions stored in the memory. The one or more processors, by executing the one or more instructions, are configured to: detect, via an acceleration sensor of the vehicle, a longitudinal acceleration of the vehicle; determine, based on the detected longitudinal acceleration of the vehicle, a limit lateral acceleration; determine, based on the limit lateral acceleration, a limit steering angle; detect, via a steering angle sensor associated with a steering wheel of the vehicle, a current steering angle; and transmit, based on the current steering angle exceeding the limit steering angle, a control signal to a power steering system via the communication interface to suppress an excessive steering angle of the vehicle.

A vehicle may comprise: a power steering system; a steering wheel; an acceleration sensor; a communication interface; a memory storing one or more instructions; and one or more processors configured to execute the one or more instructions stored in the memory. The one or more processors, by executing the one or more instructions, are configured to cause the vehicle to: detect, via the acceleration sensor, a longitudinal acceleration of the vehicle; determine, based on the detected longitudinal acceleration of the vehicle, a limit lateral acceleration; determine, based on the limit lateral acceleration, a limit steering angle; detect a current steering angle of the steering wheel; and transmit, based on the current steering angle exceeding the limit steering angle, a control signal to the power steering system via the communication interface to suppress an excessive steering angle of the vehicle.

The one or more processors, by executing the one or more instructions, may be configured to cause the vehicle to, after suppressing the excessive steering angle: detect, via the acceleration sensor, a second longitudinal acceleration of the vehicle; determine, based on the detected second longitudinal acceleration of the vehicle, a second limit lateral acceleration; determine, based on the second limit lateral acceleration, a second limit steering angle; and transmit, based on the suppressed steering angle not exceeding the second limit steering angle, a second control signal to the power steering system via the communication interface to adjust the suppressed steering angle of the vehicle.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a vehicle control device according to one example of the present disclosure.

FIG. 2 is a flowchart illustrating a steering control method according to one example of the present disclosure.

FIG. 3 is a flowchart illustrating a method to output a warning according to one example of the present disclosure.

FIG. 4 is a flowchart illustrating determining a limit lateral acceleration according to one example of the present disclosure.

FIG. 5 is a graph for explaining determining the limit lateral acceleration based on a longitudinal acceleration, according to one example of the present disclosure.

FIG. 6 is a graph of control gain according to steering angle.

FIG. 7 is a block diagram schematically illustrating an example computing device.

### DETAILED DESCRIPTION

Hereinafter, some examples of the present disclosure will be described in detail with reference to the accompanying drawings. In the following description, like reference numerals preferably designate like elements, although the elements are shown in different drawings. Further, in the following description of some examples, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof. Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The following detailed description, together with the accompanying drawings, is intended to describe examples of the present invention, and is not intended to represent the only examples in which the present invention may be practiced.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of a limit lateral acceleration and a limit steering angle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., e.g., features of a limit lateral acceleration and a limit steering angle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., e.g., features of a limit lateral acceleration and a limit steering angle) described herein.

Minimum risk maneuver (MRM) operation(s) may also be controlled, for example, based on one or more features (e.g., e.g., features of a limit lateral acceleration and a limit steering angle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle if a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., e.g., features of a limit lateral acceleration and a limit steering angle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., e.g., features of a limit lateral acceleration and a limit steering angle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

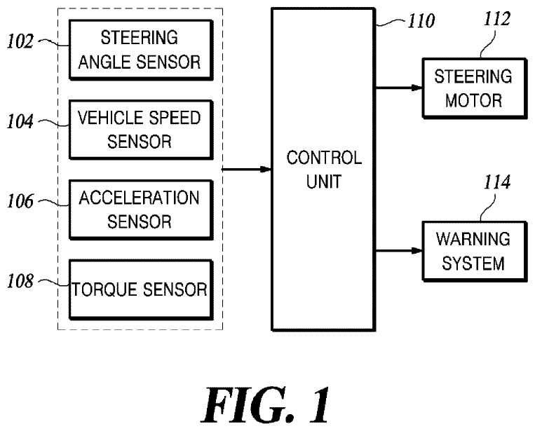

FIG. 1 is a block diagram schematically illustrating the configuration of a vehicle control device according to one example of the present disclosure.

The vehicle control device may include all or some of: a plurality of sensors 102, 104, 106, and/or 108 (the specific sensors shown are an example, but the disclosure is not limited thereto); a control unit 110 (e.g., controller/control computing device); a steering motor 112; and/or a warning system 114. The plurality of sensors 102, 104, 106, and/or 108 may obtain information for steering control herein. The control unit 110 may output a control command based on information detected and collected by a plurality of sensors 102, 104, 106, and 108. The steering motor 112 may generate reverse torque to suppress steering according to the control command output by the control unit. The warning system 114 may output a warning (e.g., alert, notification, alarm) to warn the driver based on the driver excessively steering.

Information for steering control may include driver steering input information and/or vehicle status information. The driver steering input information may include a steering torque (e.g., received from the torque sensor 108), a steering angle (e.g., received from the steering angle sensor 102), and/or a steering angle speed (e.g., received from the steering angle sensor 102 and/or determined based on the steering angle). The steering torque may include a steering wheel torque and/or column torque. The steering angle may include a steering angle and/or a column input angle. The vehicle status information may include a vehicle speed and/or a longitudinal acceleration.

The driver steering input may comprise/be based on information input to the steering system by the driver by steering the steering wheel. As such driver steering input information, the steering angle is information indicating a rotation position and/or a rotation angle of the steering wheel operated by the driver. The steering angle speed may comprise information indicating a rotational angular speed of the steering wheel operated by the driver.

The plurality of sensors may include a steering angle sensor 102, a vehicle speed sensor 104, an acceleration sensor 106, and a torque sensor 108. The steering angle sensor 102 may detect the steering angle (e.g., according to the steering wheel operation of the driver). The vehicle speed sensor 104 may detect the vehicle speed. The acceleration sensor 106 may measure longitudinal and/or lateral accelerations of the vehicle. The torque sensor 108 may detect the steering torque applied to the steering wheel by the driver.

The vehicle speed sensor 104 may be configured to include a wheel speed sensor installed on a driving wheel of the vehicle. The vehicle speed sensor 104 may determine the vehicle speed based on a signal from the wheel speed sensor. The wheel speed sensor may be a sensor that detects the rotational speed of the wheel of the vehicle and determines a driving situation of the vehicle (e.g., a speed and/or acceleration of the vehicle).

The torque sensor 108 may be configured to detect the steering torque input/applied by the driver via the steering wheel. The steering torque may be detected based on/using the degree of twist of a torsion bar of the steering wheel.

The acceleration sensor 106 is a sensor for determining the driving situation of the vehicle by detecting acceleration in the front, rear, left, and/or right directions of the vehicle. The steering angle speed may be obtained by differentiating a steering angle signal obtained by the steering angle sensor 102. The vehicle control device may further include additional sensors, such as an engine speed sensor, a yaw rate sensor, or the like (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.).

The steering actuator may comprise an actuator that generates a steering assistance force to assist the steering of the driver. In the MDPS system, the steering actuator may be configured to include a steering motor 112. The steering motor 112 may be controlled to drive according to the control command output by the control unit 110. The steering motor 112 may, based on the control command output by the control unit 110, generate and/or output the reverse torque based on a current steering angle being around or exceeding the limit steering angle. The driving of the steering motor 112 may be controlled by controlling the current applied to the motor according to the control command output by the control unit 110.

The warning system 114 may warn the driver about excessive steering. Based on the current steering angle and/or the steering angle speed (e.g., as monitored by the control unit 110), it may be determined (e.g., by the control unit 110) that the current steering angle is around and/or exceeds and/or is expected/predicted to exceed the limit steering angle. Based on a determination that the current steering angle is around and/or exceeds and/or is expected/predicted to exceed the limit steering angle, the warning system 114 may warn the driver (e.g., output a warning sound, light, image, notification, etc.) indicating/about excessive steering. The warning may be output as, for example, a sound, a display, a light, and/or Heads-Up Display (HUD), and the like.

The control unit 110 may comprise a control element that controls the overall operation of the system. The control unit 110 may include a MDPS electronic control unit (ECU). The control unit 110 may control the steering motor 112 and/or the warning system 114 based on the driver steering input information and/or the vehicle status information. The control unit 110 may be equipped to control various functions, such as a Lane Keeping Assist (LKA) function and haptic vibration, and/or an Advanced Driver Assistance System (ADAS) function.

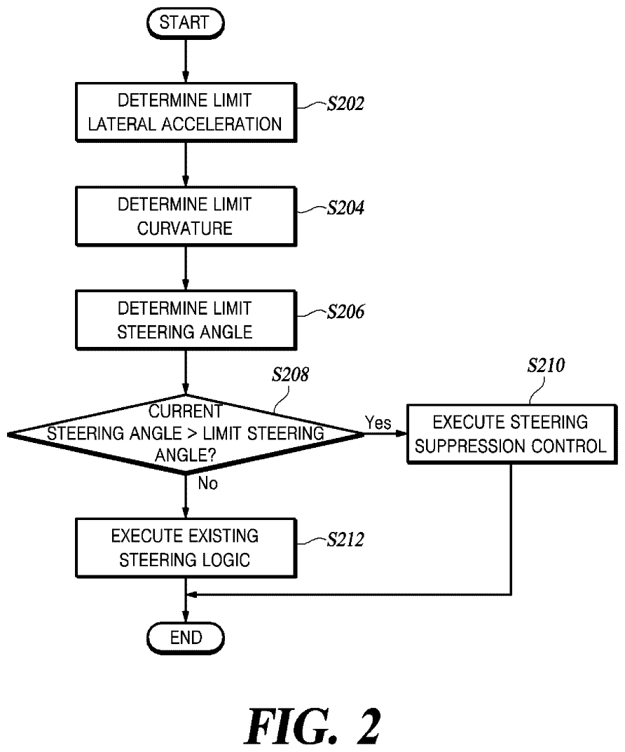

For convenience, FIGS. 2-4 are described by way of an example in which the steps are performed by a processor circuit (e.g., of the control unit 110). One, some, or all steps of the example methods of FIGS. 2-4, or portions thereof, may be performed by one or more other circuits. One or some, steps of the example methods of FIGS. 2-4 may be omitted, performed in other orders, and/or otherwise modified, and/or one or more additional steps may be added. The methods of FIGS. 2-4 may be performed as a single method, for example.

FIG. 2 is a flowchart illustrating a steering control method according to an example of the present disclosure.

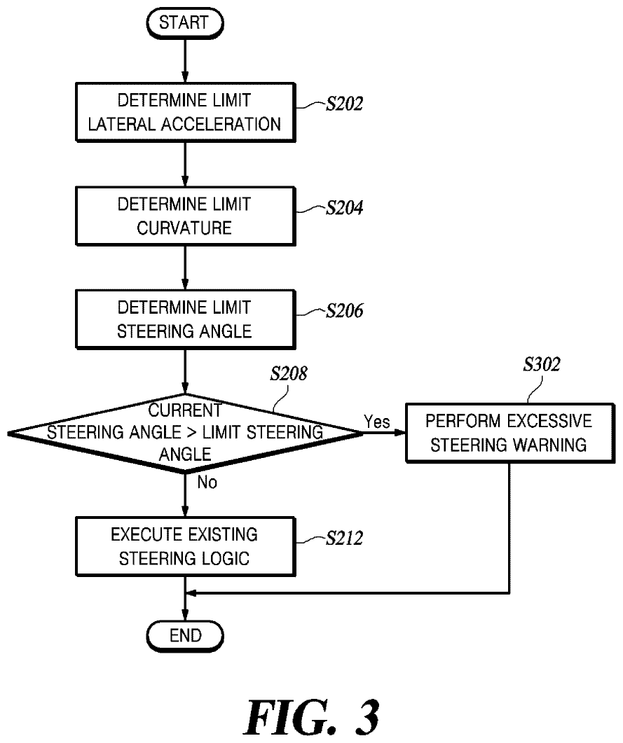

FIG. 3 is a flowchart illustrating a method to output a warning according to an example of the present disclosure.

Referring to FIGS. 2 and 3, the steering control method and/or the method to output a warning may include (S202) determining the limit lateral acceleration, (S204) determining the limit curvature, (S206) determining the limit steering angle, and (S208) determining whether the current steering angle exceeds the limit steering angle.

Referring to FIGS. 1, 2, and 3, the control unit 110 may receive at least one of the driver steering input information and/or the vehicle status information. The control unit 110 may output the control command (e.g., for steering suppression control 210) based on information detected and/or collected and/or transmitted by the plurality of sensors 102, 104, 106, and 108. Here, the control command may be determined using the limit lateral acceleration, the limit curvature, and the limit steering angle. The control unit 110 may determine whether the current steering angle exceeds the limit steering angle (S208). The control unit 110 may output the steering suppression command based on the current steering angle exceeding (and/or being predicted to exceed and/or approaching) the limit steering angle (S210). In the step 212, the control unit 110 may execute a set (e.g., default/existing) steering logic based on the current steering angle not exceeding the limit steering angle (S212).

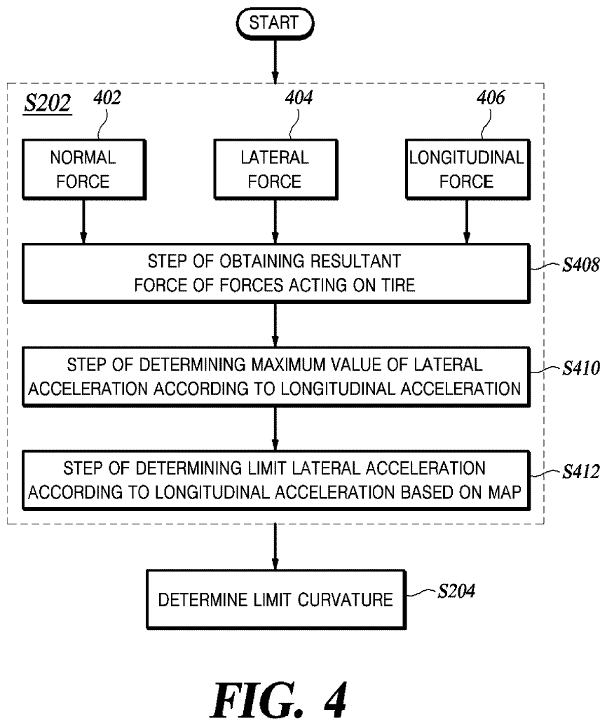

FIG. 4 is a flowchart illustrating a determining the limit lateral acceleration according to one example of the present disclosure.

Using Equation 1, a resultant force of the forces acting on the tire can be obtained using a normal force 402, a lateral force 404, and a longitudinal force 406 (S408). The resultant force acting on the tire can be defined as a friction limit with the road surface.

$${F}_{tire} = \sqrt{{F}_{x , tire}^{2} + {F}_{y , tire}^{2}} \leq μ {F}_{z , tire} \qquad [ Equation 1 ]$$

(Fₜᵢᵣₑ: sum of forces acting on tire, F_{x,tire}: longitudinal (e.g., direction of motion of tire) force on tire, F_{y,tire}: lateral force on tire (e.g., perpendicular to longitudinal force on tire), F_{z,tire}: normal force acting on tire, μ: coefficient of friction between tire and ground; longitudinal and lateral refer to orthogonal directions defining the plane of contact of the tire on a surface on which it is driving)

The limit lateral acceleration refers to the maximum lateral acceleration at which a wheel generates force within the friction limit. The limit lateral acceleration refers to the instantaneous acceleration that exceeds the friction between the wheels and the road while the vehicle is turning a curve, for example. If a force exceeding the friction limit is applied to even one wheel, the vehicle may exhibit unstable behavior.

The limit lateral acceleration may be determined/calculated using at least one of pieces of information about the longitudinal, lateral, and vertical forces of the tire under the following assumptions (S202).

The normal force 402 is generated by the weight of the vehicle. Therefore, the normal force can be obtained by multiplying the mass of the vehicle by the acceleration of gravity. However, when the vehicle accelerates or decelerates, the load moves from the center of the vehicle. The load moves forward or backward by/according to the longitudinal acceleration aₓ, and the load moves to the left and right of the vehicle by the lateral acceleration a_{y}. As this load moves, the normal force acting on each tire changes, and the relationship illustrated in Equation 2 may be obtained.

$${F}_{z , fl} = \frac{{ml}_{r}}{2 L} g - \frac{mh}{2 L} {a}_{x} - \frac{{mhl}_{γ}}{bL} {a}_{y} , {F}_{z , fr} = \frac{{ml}_{r}}{2 L} g - \frac{mh}{2 L} {a}_{x} + \frac{{mhl}_{r}}{bL} {a}_{y} \qquad [ Equation 2 ]$$

$${F}_{z , rl} = \frac{{ml}_{f}}{2 L} g + \frac{mh}{2 L} {a}_{x} - \frac{{mhl}_{f}}{bL} {a}_{y} , {F}_{z , rr} = \frac{{ml}_{f}}{2 L} g + \frac{mh}{2 L} {a}_{x} + \frac{{mhl}_{f}}{bL} {a}_{y}$$

(F_{z,fl}: normal force acting on front left tire, F_{z,fr}: normal force acting on front right tire, F_{z,rl}: normal force acting on rear left tire, F_{z,rr}: normal force acting on rear right tire, m: mass of the vehicle, lᵣ: distance from rear wheel of vehicle to center of vehicle mass, l_{f}: distance from front wheel of vehicle to center of vehicle mass, L: wheelbase of vehicle, g: gravity acceleration, h: height of center of mass, αₓ: longitudinal acceleration, α_{y}: lateral acceleration, and b: wheelbase)

If the vehicle changes direction, the lateral force 404 is generated in proportion to the lateral acceleration. The lateral force 404 acting on each wheel may be determined according to a ratio of the normal force 402 acting on the wheel. This is because the normal force of the wheel determines the friction force needed to generate the lateral force. Therefore, the lateral force 404 occurs in proportion to the lateral acceleration at the rate of the normal force 402 of each wheel, and is expressed in Equation 3.

$${F}_{y , i} = {ma}_{y} \times \frac{{F}_{z , i}}{{F}_{z , tot}} \qquad [ Equation 3 ]$$

(F_{y,i}: lateral force acting on i-th wheel, F_{z,i}: normal force acting on i-th wheel, and F_{z,tot}: total normal force acting on all wheels)

It is assumed that normalized cornering stiffness of all wheels is the same. The cornering stiffness is an indicator of a wheel characteristic related to the degree to which the wheels of the vehicle slip sideways during rotation. The same normalized cornering stiffness of all wheels means that all wheels contribute to turning characteristics of the vehicle with the same contribution. Assume that the side slip angle is the same (neutral steer). The lateral slip angle refers to the difference between the direction of the vehicle and the direction of the wheels. This phenomenon occurs when a vehicle turns a corner or turns. The same lateral slip angle means that all wheels slide sideways at the same angle. The same lateral slip indicates that turning motion of the vehicle is balanced and that the vehicle moves in a consistent direction. These assumptions are made for the purposes of estimating the forces herein and explaining the equations herein, and need not be strictly true for performing the method herein.

The longitudinal force 406 is the same on the left and right, and a force proportional to an axial load is generated front and rear, as illustrated in Equation 4.

$${F}_{x , fr} = {F}_{x , fl} = {ma}_{x} \times \frac{{F}_{z , f}}{2 {F}_{z , tot}} , {F}_{x , rr} = {F}_{x , rl} = {ma}_{x} \times \frac{{F}_{z , r}}{2 {F}_{z , tot}} \qquad [ Equation 4 ]$$

(F_{x,fl}: longitudinal force acting on front left wheel, F_{x,fr}: longitudinal force acting on front right wheel, F_{x,rl}: longitudinal force acting on rear left wheel, F_{x,rr}: longitudinal force acting on rear right wheel, F_{z,tot}: total vertical (e.g., normal herein) load, F_{z,f}: front vertical load, and F_{z,r}: rear vertical load)

It is assumed that a force proportional to the vertical load is generated forward and backward (e.g., using either a brake proportioning valve and/or Electronic Brakeforce Distribution (EBD)). The brake proportioning valve and EBD may be devices that regulate the braking force between the front and rear wheels in the brake system of the vehicle. Vehicle brakes may be installed on the front and rear wheels, respectively. If a vehicle makes a sudden stop or turns a curve, the loads on the front and rear wheels may be different. The brake proportioning valve and/or EBD may regulate the braking force between the front and rear wheels of the vehicle, maintaining equal braking effect according to the load distribution of the vehicle.

Assuming that the vehicle parameters (mass, center of gravity position, length, width, or the like) other than a longitudinal acceleration (aₓ) and a lateral acceleration (a_{y}) are known on the right side of Equation 2, the vertical force of each wheel may be expressed as a function of the longitudinal acceleration (aₓ) and the lateral acceleration (a_{y}).

By substituting the normal force (F_{z,i}) obtained from Equation 2 on the right side of Equation 3 and Equation 4, the longitudinal and lateral forces of the vehicle may also be expressed as the function of aₓ and a_{y}.

Therefore, in Equation 1, both the resultant force acting on the tire, which is the left side of the inequality, and the friction limit proportional to the normal force, which is the right side, may be expressed as a function of aₓ and a_{y}.

By organizing the left and right sides of Equation 1 expressed as the function of aₓ and a_{y}, the maximum value of the lateral acceleration a_{y} according to the longitudinal acceleration aₓ may be determined in the step S410.

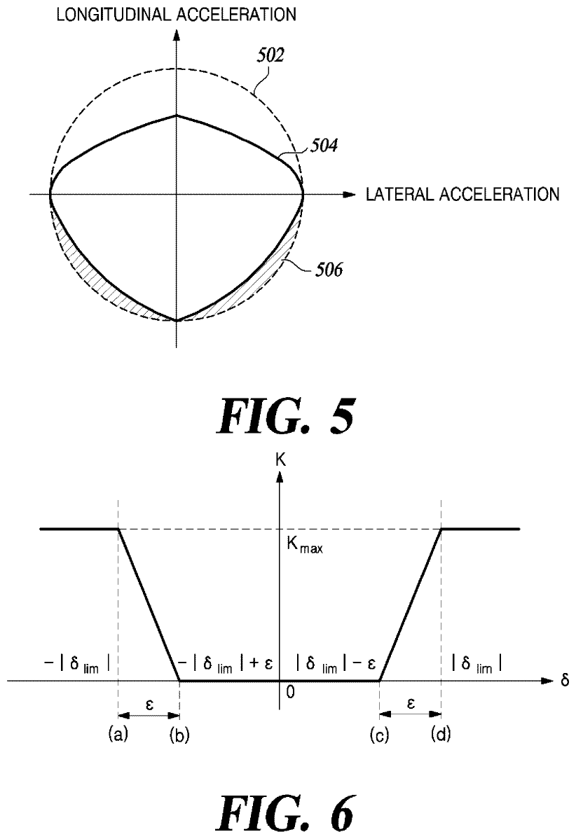

Referring to FIG. 5, the determining/calculating (e.g., by the control unit 110) the limit lateral acceleration (S412) will be described in more detail. FIG. 5 is a graph for explaining the determining the limit lateral acceleration based on longitudinal acceleration, according to one example of the present disclosure. An x-axis of the graph means the lateral acceleration, and a y-axis means longitudinal acceleration.

The control unit 110 may calculate/determine the maximum value of the lateral acceleration for all wheels to travel in a stable region according to the longitudinal acceleration. Reference numeral 504 in FIG. 5 indicates limit lines for the longitudinal and lateral acceleration. Reference number 502 in FIG. 5 indicates an acceleration limit value in an elliptical shape that is mainly used in the related art. Reference number 506 in FIG. 5 indicates an acceleration region in which stable driving is not possible. Referring to the graph of FIG. 5, the limit lateral acceleration may be determined for/corresponding to the currently obtained longitudinal acceleration. For example, if a specific longitudinal acceleration is obtained and a straight line parallel to the x-axis is drawn accordingly (e.g., at the specific longitudinal acceleration), the straight line meets the reference number 504 at one or two points in FIG. 5. The x value of that point(s) can be determined as the limit lateral acceleration (e.g., which may be symmetric to the left and right).

Since the longitudinal force 406, the lateral force 404, and the normal force 402 of each wheel are all considered herein, the limit lateral acceleration having a more accurate physical meaning than assuming that the acceleration limit of the entire vehicle is elliptical (502) may be obtained. In addition, since the limit lateral acceleration according to the longitudinal acceleration is calculated based on a map, unlike the related art, real-time calculations for complex dynamics are unnecessary, and the accurate limit lateral acceleration may be determined without complicated calculations.

In S204, the control unit 110 may determine a limit curvature at which the vehicle can drive stably based on (e.g., by considering) the obtained limit lateral acceleration information and the current vehicle speed (e.g., obtained by the vehicle speed sensor 104 of the acquisition unit). The limit curvature is the same as Equation 5.

$${ρ}_{lim} = {a}_{y , lim} / {v}_{x}^{2} \qquad [ Equation 5 ]$$

(ρₗᵢₘ: limit curvature, α_{y,lim}: limit lateral acceleration, and νₓ: longitudinal speed of vehicle)

The limit curvature may represent the maximum curvature at which the vehicle can safely/stably turn (e.g., without slipping or tipping). The limit curvature refers to the limit at which a vehicle can safely follow a road of a certain curvature at a given speed. Here, the limit curvature may refer to a curvature where a centripetal acceleration is equal to the limit lateral acceleration, assuming that the vehicle is a point mass for the purpose of calculation.

In S206, the limit steering angle according to the limit curvature is determined using the Ackermann steering angle. The Ackermann steering angle refers to a difference in rotation angle between the inner and outer wheels when the vehicle turns a corner. The Ackermann steering angle is calculated as Equation 6.

$$tan δ ≅ δ = \frac{L}{R} = L ρ \qquad [ Equation 6 ]$$

(δ: steering angle, L: wheelbase length of vehicle, R: turning radius of vehicle, and ρ: curvature)

The limit steering angle can be obtained by substituting Equation 6. The result of the substitution is as illustrated in Equation 7.

$$\vert {δ}_{lim} \vert = L \vert {ρ}_{lim} \vert \qquad [ Equation 7 ]$$

(δₗᵢₘ: limit steering angle)

The determined limit steering angle refers to the limit value of the steering angle that allows all tires are subjected to frictional force within the stable friction region based on the longitudinal acceleration.

In S208, the control unit 110 may determines whether the current steering angle exceeds the limit steering angle. In response to the determination, the control unit 110 may output a control command to suppress excessive steering angle of the vehicle. The suppressing excessive occurrence of steering angle includes all or some of a method of suppressing the occurrence of steering angle by performing reverse torque generation control above the limit steering angle (S210) and a method of warning the driver about excessive steering using the warning system when the current steering angle is expected to exceed the limit steering angle (S302).

The step S210 may be performed only for angles greater than the limit steering angle (e.g., based on detected and/or expected angles greater than the limit steering angle). Control may be performed with a margin (ε) set in consideration of the responsiveness of the controller and actuator, for example. The margin (ε) is a value within a range above zero and below the limit steering angle. The equation for the steering torque of the vehicle is as illustrated in Equation 8.

$$T = - K \times ( \vert δ \vert - \vert {δ}_{lim} \vert - ε ) \qquad [ Equation 8 ]$$

(T: steering torque, K: control gain, ε: margin)

FIG. 6 illustrates a graph of control gain K vs steering angle S. The control gain has a shape that gradually increases with a set margin. In a section of steering angle (δ<(α), δ>(d)) above the limit steering angle, a reverse torque is generated to control the occurrence of steering angle. No torque is generated in a section ((b)<δ<(c)) equal to or more than the margin set in the limit steering angle. In the set margin section ((a)<δ<(b), (c)<δ<(d)), the reverse torque is generated in proportion to the current steering angle.

The above suppression control is an example, and any control method that suppresses the occurrence of steering angle through control of reverse torque generation above the limit steering angle (or near the limiting steering angle) can be used. Depending on the logic design strategy, a control method that makes the steering wheel feel heavier near the limit steering angle or a control method that completely limits the occurrence of steering angles above the limit steering angle can be implemented.

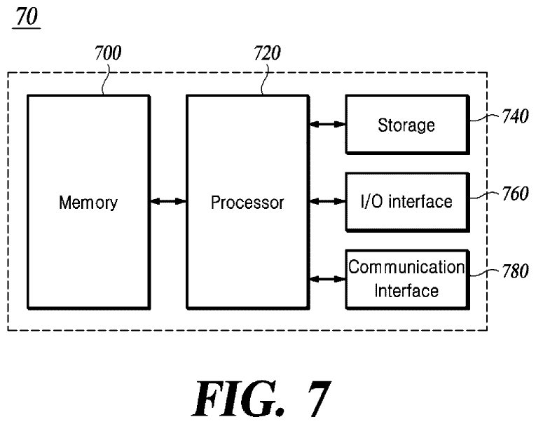

FIG. 7 is a block diagram schematically illustrating an example computing device that can be used to implement the methods or devices according to examples of the present disclosure (e.g., the control unit 110 and/or other devices disclosed herein).

A computing device 70 may include some or all of a memory 700, a processor 720, a storage 740, an input and output (I/O) interface 760, and a communication interface 780. The computing device 70 may structurally and/or functionally include at least a portion of the control unit 110 and the warning system 114. The computing device 70 may be a stationary computing device such as a desktop computer, a server, or an AI accelerator, or a mobile computing device such as a laptop computer or a smart phone.

The memory 700 may store a program that allows the processor 720 to perform methods or operations according to various examples of the present disclosure. For example, the program may include a plurality of instructions that are executable by the processor 720. The method illustrated in FIG. 2, FIG. 3 and FIG. 4 may thus be performed based on execution of the plurality of instructions by the processor 720.

The memory 700 may be a single memory or a plurality of memories. In this case, information required to perform methods or operations according to various examples of the present disclosure may be stored in the single memory or divided and stored in the plurality of memories. When the memory 700 is configured of the plurality of memories, the plurality of memories may be physically separated.

The memory 700 may include at least one of a volatile memory and a non-volatile memory. The volatile memory includes a static random access memory (SRAM), a dynamic random access memory (DRAM), or the like, and the non-volatile memory includes a flash memory.

The processor 720 may include at least one core capable of executing at least one instruction. The processor 720 may execute instructions stored in the memory 700. The processor 720 may be a single processor or a plurality of processors.

The storage 740 maintains stored data even when power supplied to the computing device 70 is cut off. For example, the storage 740 may include a non-transitory computer readable medium, such as a non-volatile memory and/or a storage medium such as a magnetic tape, optical disc, or magnetic disk.

A program (e.g., instructions and/or data as discussed herein) stored in the storage 740 may be loaded into the memory 700 before being executed by the processor 720. The storage 740 may store files created in a program language, and a program created from a file by a compiler or the like may be loaded into the memory 700. The storage 740 may store data to be processed by the processor 720 and/or data processed by the processor 720.

The I/O interface 760 may provide an interface with an input device such as a keyboard or mouse, and/or an output device such as a display device or printer. An user can trigger execution of a program in the processor 720 through the input device and/or check a processing result of the processor 720 through the output device.

The communication interface 780 may provide access to an external network. For example, the computing device 70 may communicate with another device (for example, the control unit 110 and the warning system 114) via the communication interface 780.

A main purpose of the present disclosure is to provide an algorithm that sets a steering limit in terms of vehicle stability and prevents excessive steering angles from occurring.

The aspects of the present disclosure are not limited to the foregoing, and other aspects not mentioned herein will be able to be clearly understood by those skilled in the art from the following description.

According to an aspect of the present disclosure, a method for controlling a vehicle, the method comprising, obtaining a longitudinal acceleration of the vehicle, determining a limit lateral acceleration based on the longitudinal acceleration of the vehicle, determining a limit steering angle based on the limit lateral acceleration, determining whether a current steering angle exceeds the limit steering angle and suppressing excessive steering angle of the vehicle in response to a determination that the current steering angle exceeds the limit steering angle.

According to another aspect of the present disclosure, an apparatus for controlling a vehicle, the apparatus comprising, a memory configured to store one or more instructions and one or more processors configured to execute the one or more instructions stored in the memory, wherein the one or more processors, by executing the one or more instructions, perform steps comprising, obtaining a longitudinal acceleration of the vehicle, determining a limit lateral acceleration based on the longitudinal acceleration of the vehicle, determining a limit steering angle based on the limit lateral acceleration, determining whether a current steering angle exceeds the limit steering angle and suppressing excessive steering angle of the vehicle in response to a determination that the current steering angle exceeds the limit steering angle.

According to one example of the present disclosure, excessive steering of a driver input to the extent of vehicle instability can be suppressed by using an algorithm that prevents the steering angle from occurring excessively.

The effects of the present disclosure are not limited to the effects mentioned above, and other effects not mentioned may be clearly understood by those skilled in the art from the description below.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various examples of systems and techniques described herein can be realized with digital electronic circuits, integrated circuits, field programmable gate arrays (FPGAs), application specific integrated circuits (ASICs), computer hardware, firmware, software, and/or combinations thereof. The various examples can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one example of the present disclosure. In other words, those skilled in the art to which one example of the present disclosure belongs may appreciate that various modifications and changes can be made without departing from essential features of an example of the present disclosure, that is, the sequence illustrated in the flowcharts/timing charts can be changed and one or more operations of the operations can be performed in parallel. Thus, flowcharts/timing charts are not limited to the temporal order.

Although examples of the present disclosure have been described for illustrative purposes, those skilled in the art will appreciate that various modifications, additions, and substitutions are possible, without departing from the idea and scope of the claimed invention. Therefore, examples of the present disclosure have been described for the sake of brevity and clarity. The scope of the technical idea of the present examples is not limited by the illustrations. Accordingly, one of ordinary skill would understand that the scope of the claimed invention is not to be limited by the above explicitly described examples but by the claims and equivalents thereof.

What is claimed is:

1. A method performed by an apparatus of a vehicle, the method comprising:
detecting, via an acceleration sensor of the vehicle, a longitudinal acceleration of the vehicle;
determining, by the apparatus and based on the detected longitudinal acceleration of the vehicle, a limit lateral acceleration;
determining, by the apparatus and based on the limit lateral acceleration, a limit steering angle;
detecting, via a steering angle sensor associated with a steering wheel of the vehicle, a current steering angle; and
transmitting, based on the current steering angle exceeding the limit steering angle, a control signal, from the apparatus to a power steering system of the vehicle, to suppress an excessive steering angle of the vehicle.

2. The method of claim 1, wherein the determining the limit steering angle comprises determining a limit curvature.

3. The method of claim 2, wherein the determining the limit curvature comprises determining, by the apparatus the limit curvature based on information of the limit lateral acceleration and a current vehicle speed.

4. The method of claim 1, wherein the determining the limit lateral acceleration comprises determining, by the apparatus, the limit lateral acceleration based on, for each tire, at least one of:
a normal force,
a lateral force, or
a longitudinal force.

5. The method of claim 1, wherein the determining the limit lateral acceleration comprises determining, by the apparatus, the limit lateral acceleration based on at least one of a mass of the vehicle, a moment of inertia of the vehicle, a wheelbase length of the vehicle, a center of gravity position of the vehicle, or a vehicle width.

6. The method of claim 1, wherein the determining the limit lateral acceleration comprises determining, by using a map, the limit lateral acceleration based on the longitudinal acceleration, wherein the map indicates coordinates determined by a plurality of longitudinal acceleration values and a plurality of limit lateral acceleration values, and wherein each of the plurality of longitudinal acceleration values corresponds to one of the plurality of limit lateral acceleration values.

7. The method of claim 1, wherein the determining the limit steering angle comprises calculating, by the apparatus, the limit steering angle based on the longitudinal acceleration at which all tires are subjected to frictional force within a stable friction region.

8. The method of claim 1, wherein the excessive steering angle is suppressed by generating, by the power steering system, a reverse torque.

9. The method of claim 1, further comprising causing output, based on the current steering angle being predicted to exceed the limit steering angle, of a warning signal via an output device of the vehicle.

10. An apparatus for controlling a vehicle, the apparatus comprising:
a communication interface;
a memory storing one or more instructions; and
one or more processors configured to execute the one or more instructions stored in the memory,
wherein the one or more processors, by executing the one or more instructions, are configured to:
detect, via an acceleration sensor of the vehicle, a longitudinal acceleration of the vehicle;
determine, based on the detected longitudinal acceleration of the vehicle, a limit lateral acceleration;
determine, based on the limit lateral acceleration, a limit steering angle;
detect, via a steering angle sensor associated with a steering wheel of the vehicle, a current steering angle; and
transmit, based on the current steering angle exceeding the limit steering angle, a control signal to a power steering system via the communication interface to suppress an excessive steering angle of the vehicle.

11. The apparatus of claim 10, wherein the one or more processors, by executing the instructions, are configured to determine the limit steering angle based on a limit curvature.

12. The apparatus of claim 11, wherein the one or more processors, by executing the instructions, are configured to determine the limit curvature based on information of the limit lateral acceleration and a current vehicle speed.

13. The apparatus of claim 10, wherein the one or more processors, by executing the instructions, are configured to determine the limit lateral acceleration based on, for each tire, at least one of:
a normal force,
a lateral force, or
a longitudinal force.

14. The apparatus of claim 10, wherein the one or more processors, by executing the instructions, are configured to determine the limit lateral acceleration based on at least one of a mass of the vehicle, a moment of inertia of the vehicle, a wheelbase length of the vehicle, a center of gravity position of the vehicle, or a vehicle width.

15. The apparatus of claim 10, wherein the one or more processors, by executing the instructions, are configured to determine, by using a map, the limit lateral acceleration based on the longitudinal acceleration, and
wherein the map indicates coordinates determined by a plurality of longitudinal acceleration values and a plurality of limit lateral acceleration values, and wherein each of the plurality of longitudinal acceleration values corresponds to one of the plurality of limit lateral acceleration values.

16. The apparatus of claim 10, wherein the one or more processors, by executing the instructions, are configured to cause the power steering system to generate a reverse torque to suppress the excessive steering angle.

17. The apparatus of claim 10, wherein the limit steering angle is identified by the apparatus based on the longitudinal acceleration at which all tires are subjected to frictional force within a stable friction region.

18. The apparatus of claim 10, wherein the one or more processors, by executing the instructions, are configured to control an output device of the vehicle to output, based on the current steering angle being predicted to exceed the limit steering angle, a warning signal.

19. A vehicle comprising:
a power steering system;
a steering wheel;
an acceleration sensor;
a communication interface;
a memory storing one or more instructions; and
one or more processors configured to execute the one or more instructions stored in the memory,
wherein the one or more processors, by executing the one or more instructions, are configured to cause the vehicle to:
detect, via the acceleration sensor, a longitudinal acceleration of the vehicle;
determine, based on the detected longitudinal acceleration of the vehicle, a limit lateral acceleration;
determine, based on the limit lateral acceleration, a limit steering angle;
detect a current steering angle of the steering wheel; and
transmit, based on the current steering angle exceeding the limit steering angle, a control signal to the power steering system via the communication interface to suppress an excessive steering angle of the vehicle.

20. The vehicle of claim 19, wherein the one or more processors, by executing the one or more instructions, are configured to cause the vehicle to, after suppressing the excessive steering angle:
detect, via the acceleration sensor, a second longitudinal acceleration of the vehicle;
determine, based on the detected second longitudinal acceleration of the vehicle, a second limit lateral acceleration;
determine, based on the second limit lateral acceleration, a second limit steering angle; and
transmit, based on the suppressed steering angle not exceeding the second limit steering angle, a second control signal to the power steering system via the communication interface to adjust the suppressed steering angle of the vehicle.
